(19) United States
(12) Patent Application Publication
(10) Pub. No.: US 2007/0127011 A1
(43) Pub. Date: Jun. 7, 2007

(54) Method and Apparatus for Measuring the Angular Orientation Between Two Surfaces

(76) Inventor: Mark V. Loen, Maricopa, AZ (US)

Correspondence Address: MARK V. LOEN, 43649 W BAILEY DR., MARICOPA, AZ, 85239, US

(21) Appl. No.: 11/671,368

(22) Filed: Feb. 5, 2007

Related U.S. Application Data
(63) Continuation-in-part of application No. 10/932,895, filed on Sep. 2, 2004.
(60) Provisional application No. 60/500,940, filed on Sep. 8, 2003.

(51) Int. Cl. G01B 11/26

(52) U.S. Cl. 356/138

(57) ABSTRACT

A device and method are disclosed that measure the relative angular orientation between two surfaces. Two frames are mounted on the two surfaces to be measured. A collimated light is reflected between the frames and its position is read on a scale. The frame with the collimated light is flipped over and a second position measurement is taken. The difference in position is used to calculate the non-parallel angle between the two rolls. The method and measuring scale can be adapted to provide accurate measurement of very small, near parallel orientation angles. The two frames can be adapted to measure the angular orientation of important surfaces such as rolls or odd shapes that are otherwise difficult to measure.

### RELATED APPLICATIONS

This application is a continuation in part of U.S. patent application Ser. No. 10/932,895 filed on Sep. 2, 2004, which claims the benefit of U.S. Provisional Patent Application Ser. No. 60/500,940 filed on Sep. 8, 2003. The entire application Ser. No. 10/932,895 is incorporated by reference herein.

This application claims the benefit of U.S. patent application Ser. No. 11/190,622 filed on Jul. 28, 2005, which claims the benefit of U.S. Provisional Patent Application Ser. No. 60/687,121 filed on Jun. 6, 2005, and was a continuation in part of U.S. patent application Ser. No. 10/802,338 filed on Mar. 18, 2004 which claims the benefit of U.S. Provisional Patent Application No. 60/474,799 filed on Jun. 2, 2003.

### STATEMENT REGARDING FEDERALLY SPONSORED RESEARCH OR DEVELOPMENT

Not Applicable.

### REFERENCE TO SEQUENCE LISTING, A TABLE, OR COMPUTER PROGRAM LISTING

Not Applicable.

### BACKGROUND OF THE INVENTION

1. Field of the Invention

The present invention is generally directed to measuring the relative angular orientation of one surface to another surface. In particular, the invention is especially useful for measuring the angular orientation of two nearly parallel surfaces. The two surfaces are assumed to be in a side by side arrangement rather than in line with each other.

The desirability of measuring the angular orientation of difficult to measure surfaces is an important matter for efficient and practical production of many items. In particular, it is important to measure the parallel alignment of neighboring processing rolls in order to make paper, film, or metal strip. The rolls are normally aligned to very small parallel angular tolerances. The small angles are very difficult to determine accurately and currently requires methods utilizing highly trained technicians and specialized equipment

2. Discussion of the Prior Art

Methods to measure roll to roll parallel alignment have been described in previous patents and patent applications already referenced.

### BRIEF SUMMARY OF THE INVENTION

Accordingly, it is the object of this invention to directly and accurately measure the parallel angular orientation between two surfaces, providing important improvements to previous methods and issued patents currently in use.

### BRIEF DESCRIPTION OF THE SEVERAL VIEWS OF THE DRAWINGS

FIG. 1 shows an embodiment of the device where the collimated light beam is directed toward a mirror which reflects it back to an electronic position sensitive detector (PSD).

FIGS. 2A-2D show how the collimated light projecting frame can be ‘flipped over’ to provide a highly accurate angular calculation when two position readings are taken on a scale.

FIG. 3 shows various features that provide for convenient operator interface when a PSD is used.

FIGS. 4A-4B shows a preferred embodiment where the collimated light beam and the reflecting mirror each rotate on an axis on their respective frames.

FIG. 5 shows how the current device can be adapted to provide targeting of stationary and moving vehicles when a line of sight exists.

### DETAILED DESCRIPTION OF THE INVENTION

The present invention consists of two frames that are mounted on the two surfaces to be measured. A collimated light beam on the first frame is projected onto a mirror mounted on the second frame. The beam is reflected back to the first frame where the position of the beam on a scale is recorded. The first frame is flipped over, remounted on the same surface, and the collimated light beam is reflected back onto the same scale a second time. The change between the two beam positions on the scale, as well as the distance between the first and second frame, is used to compute the angular orientation between the two frames. The measuring method does not generally require any angular calibration to obtain an accurate reading.

A main feature of the present invention is that the projection of the beam does not have to be perpendicular to the first frame with high precision. The exact projection angle does not matter for accuracy. The projection angle only has to be reasonably perpendicular so that the beam will actually fall on the scale for each reading.

The present invention includes two frames that are mounted on the two surfaces where the angular orientation of the two surfaces is to be measured. The first frame has a collimated light source, such as a diode laser beam, that projects a light beam approximately perpendicular to the first surface. The first frame also includes a measuring scale. The second frame has a mirror that reflects the collimated light source backward toward the scale on the first frame. The collimated light source is switched on and the collimated light is directed toward the second frame mirror while maintaining the first frame alignment to the first surface. The second frame is then adjusted so that the reflected collimated light beam is directed toward the scale on the first frame while maintaining the second frame alignment to the second surface. The position of the collimated light beam on the scale is used to calculate the non-parallel angle between the two rolls. The accuracy of this measuring method improves as the two frames are spaced further apart. The term scale means a position indicating instrument adapted to measuring the position of the collimated light beam.

The angular orientation between the two surfaces is measured in a plane that is substantially the average light beam path and the lengthwise measuring orientation of the scale. Twisting between the two frames relative to the plane of measurement will cause unwanted measuring errors. For best accuracy, twist angles above 10 degrees should be avoided.

As a convenience feature, a level indicating instrument can be incorporated into either frame, such as a vial with a bubble.

The invention does not require the collimated light beam to be projected perpendicular to the first surface or to be projected on a particular location on the mirror. In a preferred embodiment, a method is used where two scale readings are taken. A first reading of the collimated light beam position on the scale is made, and then the frame with the collimated light source and scale is flipped over. A second reading is then taken. The difference between the two readings and the distance between the two frames is used to calculate the non-parallel angle β:

$$β = {tan}^{- 1} [ \frac{{Reading}_{1} - {Reading}_{2}}{4 ( Distance Between Units )} ] \qquad eqn 1$$

When the angle β is zero, the angular orientation is parallel.

Preferably, the distance between the two frames is sensed and used in a calculation performed electronically. Alternatively, the distance may be an input to an electronic calculation through an operator display or knob. As another alternate, the angle may be computed manually if the two scale readings are known.

In one preferred embodiment the collimated light beam source is placed on a rotational axis on the first frame. The frame is designed so that the light source rotational axis is parallel to the surface to be measured. This feature provides an easy adjustment of the collimated light beam position so that it projects onto the second frame mirror. This is a helpful and convenience feature when the frames are a larger distance apart. Similarly, the mirror on the second frame can also be placed on a rotational axis on the second frame parallel to the second surface. This feature provides an easy adjustment of the reflected collimated light beam so that it projects onto the scale which is mounted on the first frame.

The invention can be adapted to measuring the angular orientation of many kinds of surfaces. The frames may include an edge or a surface that matches the surface to be measured. Additional jigs or frames may be attached to a surface to project a more convenient object for measuring the angular orientation. Convenient surfaces include such items as pins, rods, channels, shafts, machined groves, tapered rods, snaps, clips, clamps, holes, and the like.

The two frames do not require a particular longitudinal orientation on the surfaces to be measured provided that the mirror is flat and parallel to the surface it is attached to. That is, the frames don't have to be exactly centered on the surface they sit on. The projection of the collimated light only has to strike anywhere on the mirror surface and be reflected back onto the scale.

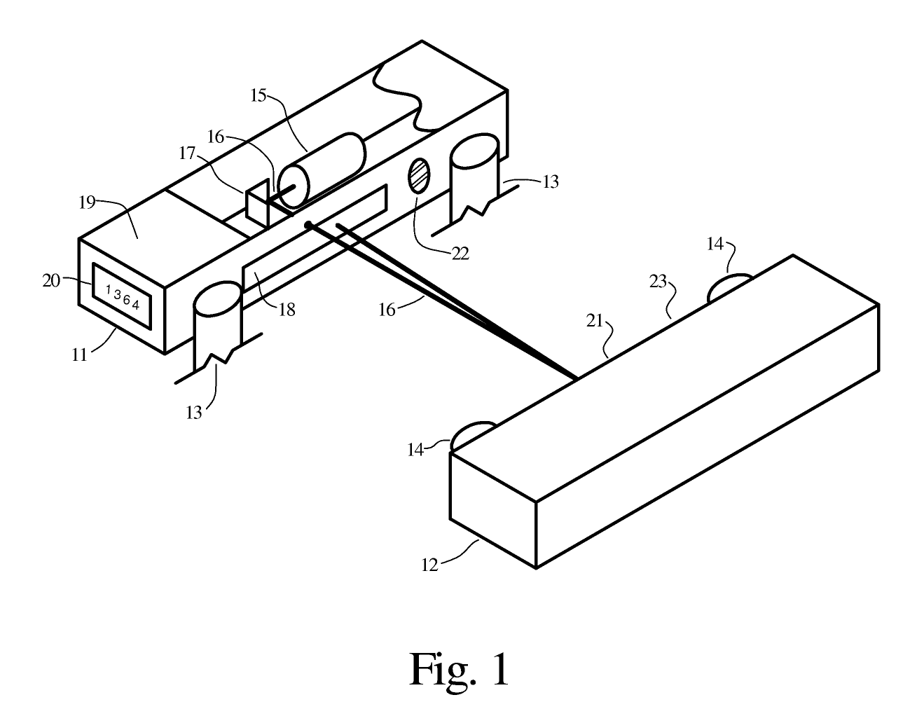

FIG. 1 shows a preferred embodiment of the invention. The non-parallel angle between four pins is to be measured. A first frame 11 is aligned to a pair of vertical pins 13, and a second frame 12 is aligned to a different pair of vertical pins 14. A diode laser 15 projects a collimated light beam 16 toward a 45 degree mirror 17. The light beam reflects off of the mirror 17 and is projected toward the second frame 12 where a flat mirror 21 is on the surface of frame 12 that is not visible from this view. The collimated light beam is reflected by the flat mirror 21 and is projected toward a scale. The scale is a PSD 18. A small, dedicated electronic computer 19 determines the alignment angle of the two frames and displays the angle readout 20. A distance sensor 22, utilizing light, measures the distance between the frames by use of a light reflector 23 mounted on the surface not visible.

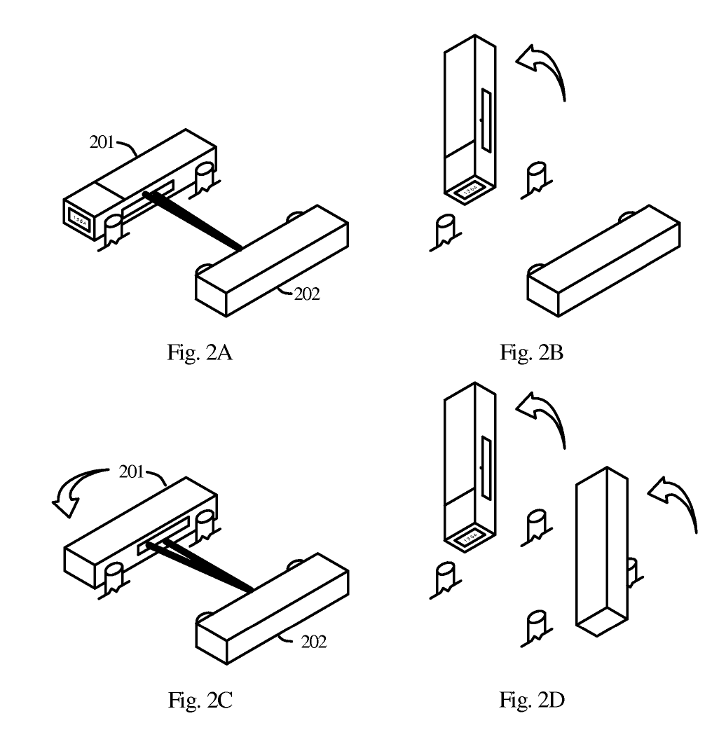

FIG. 2A-2C shows how a highly accurate alignment measurement can be achieved. Similar to FIG. 1, in FIG. 2A the two frames 201, 202 are in their aligned position and a first reading from the scale is taken. In FIG. 2B, the first frame 201 is flipped over as illustrated. FIG. 2C shows the two frames 201, 202 in measuring position, and a second reading from the scale is taken. The difference between the two readings according to equation 1 is the non-parallel angle. As an alternate, both of the frames 201, 202 can be flipped over before the second reading is taken. If frame 202 is correctly made and the reflecting mirror on frame 202 is accurately aligned to the surface being measured, frame 202 does not need to be flipped over to obtain an accurate angular reading. FIG. 2D shows an alternate method where both frames are flipped over.

The first reading taken in FIG. 2A can be considered a zero reading. If a PSD is used for the scale, it allows a computer to establish the initial position of the laser beam on the PSD, and the amount of light received. It is helpful to ensure that the projected laser beam is reflected on the PSD in a repeatable manner, that is, the same amount of light is seen by the PSD for both readings. It is not a strict requirement however, because the PSD senses the average position of the light beam, and the total amount of light only has to be reasonable to establish the position without significant error.

The ability to flip the first frame over and take two readings provides an extraordinary ability to accurately measure the non-parallel angle. It is difficult to accurately project the collimated light source perpendicular to the first frame alignment as the angle is easily disturbed by thermal effects. Warm up and cool down of the first frame causes significant accuracy problems. The warm up of the laser causes angular drift. The ‘flip over’ method eliminates many accuracy concerns and required compensation methods.

When following the teachings of the current invention, the thermal drift and calibration of the collimated light beam are not significant. The position readings of the collimated light on the PSD are made sequentially and quickly, eliminating concerns for thermal drift. Also, the unit does not require frequent calibration to ensure high accuracy.

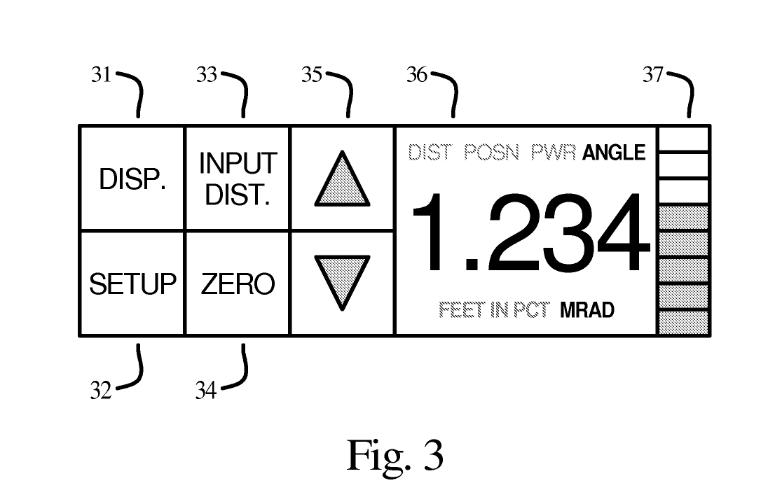

FIG. 3 shows various features that provide for convenient operator interface when a PSD is used. A keypad—operator interface is shown. The keypad may be mounted on the first frame with the laser and PSD, or it may be used in a separate, handheld device that is attached to the first frame with a cable. The various keypad functions are as follows. The DISP. button 31 is used for changing the display between distance, position of the laser on the PSD, power output of the PSD, and angle display. The SETUP button 32 allows the user to enter the programming function to access various features such as units, etc. in a setup mode. The INPUT DIST. button 33 allows an operator to directly input the distance between the two frames. The ZERO button 34 is pressed after the first reading is taken, before the frame is flipped over. The UP/DOWN buttons 35 allow the operator to enter information for setup features and the distance. The display area 36 is where the unit shows the distance between frames, the position of the laser beam on the PSD, the power output of the PSD in percentage of maximum, and the non-parallel angle between the two frames. Also, various setup features are displayed in the setup mode. A vertical bar output 37 shows the power output of the PSD in a percentage of maximum. This is displaying all the time and is helpful for an operator to ensure that an accurate reading will be made.

Various features for convenience may be added to the operator display. An important feature would be a display flip. Since the unit may be upside down relative to the display, a button to invert the display would be helpful to allow convenient reading.

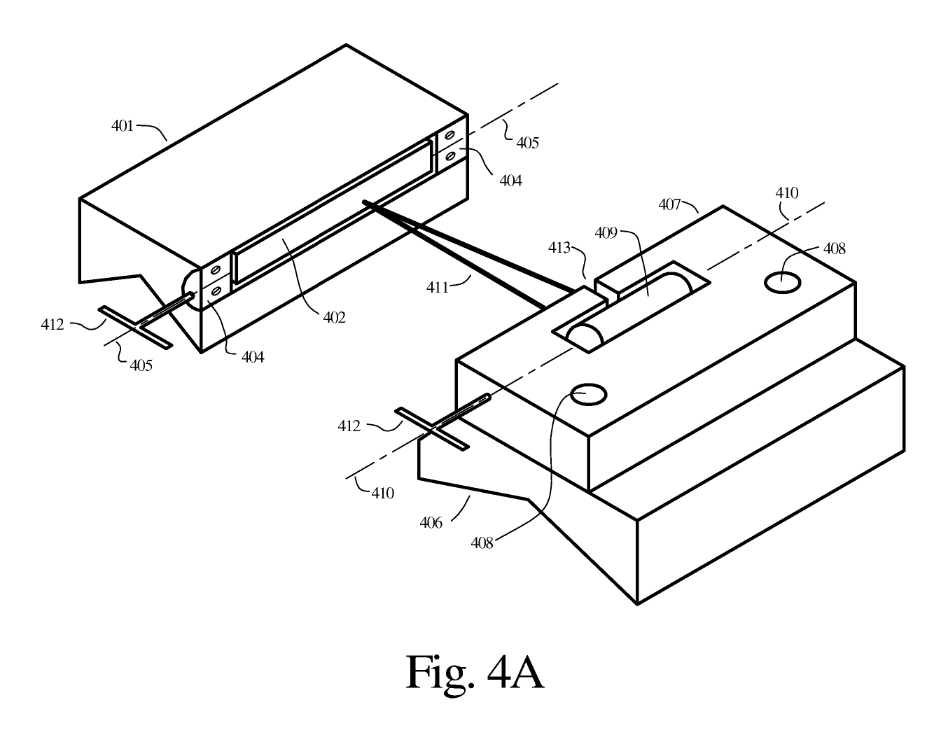

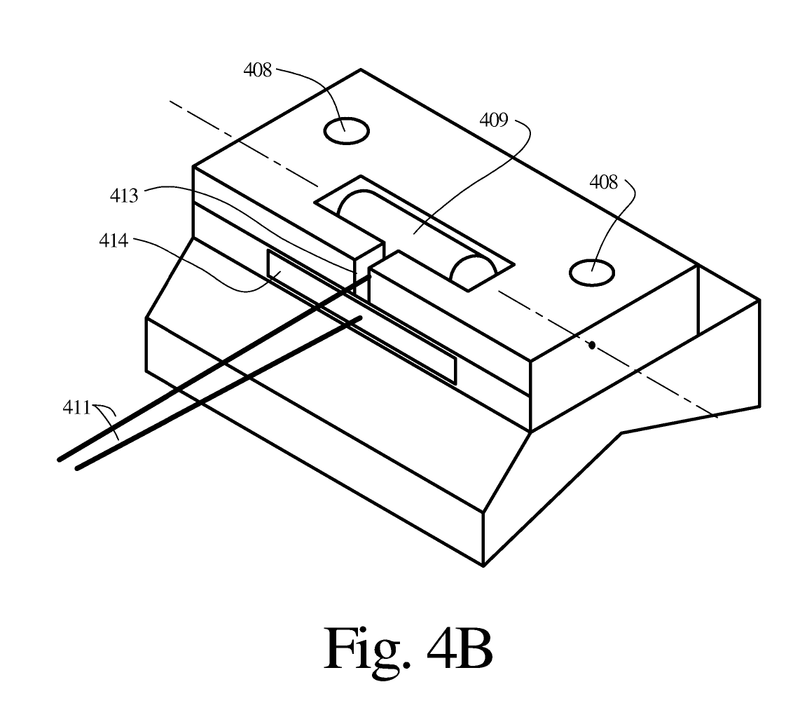

FIG. 4A shows a preferred embodiment where the collimated light beam and the mirror each rotate on an axis on their respective frames. A bottom jig 406 is attached to a roll surface and a second frame 401 is similarly attached to a different roll surface. Rectangular frame 407 is connected to the bottom jig 406 by pin 408 inserts. The pins 408 are rigidly attached to bottom jig 406. Carefully machined and positioned through holes are in rectangular frame 407 fit over the pins 408. The position of the pins 408 on the bottom jig 406 are carefully located to be parallel to the roll surface the bottom jig is attached to.

A mirror 402 on the second frame 401 pivots around rotational axis 405 which is carefully aligned to the bottom surface of second frame 401 so that the rotational axis 405 is parallel to the surface second frame 401 is attached to. A convenient tool 412, such as an Allen Wrench, is used to rotate the mirror 402 which is held in place by end blocks 404 that allow the mirror to rotate.

A collimated light source 409, such as a diode laser, is mounted in a way to rotate about rotational axis 410 and project a collimated light 411 substantially perpendicular to the rotational axis 410. The rotational axis 410 is carefully aligned to be parallel to the through holes in rectangular frame 407, and is therefore aligned to pins 408. The collimated light source 409 may be rotated by use of a convenient tool 412. A slot 413 in rectangular frame 407 allows the collimated light 411 to project toward the mirror 402 for a range of collimated light 411 rotations.

FIG. 4B shows a different view of the first frame and bottom jig with the collimated light source 409 projecting a collimated light beam 411. As shown, the slot opening 413 for the collimated light beam 411 is above the PSD 414.

FIGS. 4A and 4B provide an accurate and convenient way where the rectangular frame 407 can be readily flipped over. The rectangular frame 407 is oriented by the pins 408 which allow it to be conveniently flipped over, reoriented to the pins 408, and a second scale reading taken.

Alternately, as another embodiment, in FIGS. 4A and 4B, the scale could be mounted on the lower jig. The flipping over feature in the present invention is primarily directed toward the collimated light source. Since the alignment between the lower jig and the upper frame in FIG. 4A is maintained through close tolerance pins, the collimated light can be made to project outwardly from the first frame at the exact same location relative to the scale. The angular determination would be accurate. However, this requires careful manufacturing tolerances to ensure that the collimated light beam is projected outwardly from the same spot.

The term ‘flipped over’ would mean that at least the portion of the frame containing the collimated light source is lifted up, rotated 180 degrees, and remounted. It would not require the scale to be flipped over as well. However, in a preferred embodiment, both the scale and collimated light source are flipped over.

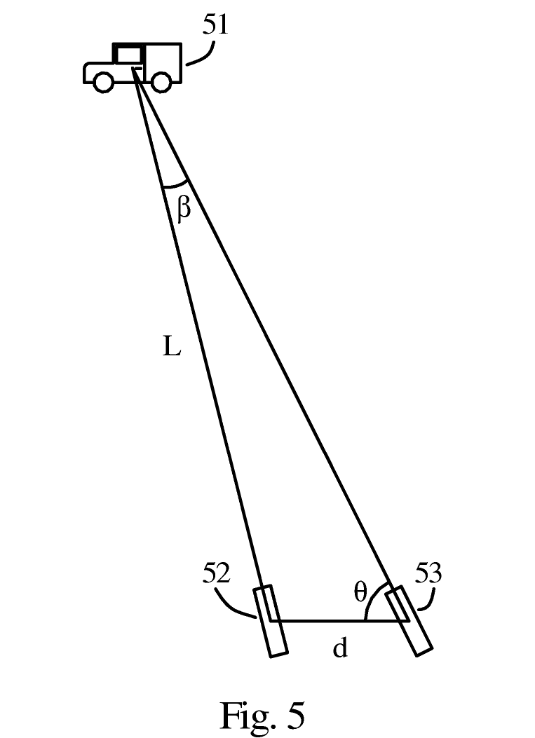

The present invention is also suited for adaptation to a military targeting system. A small shooting team, for example, will be able to accurately determine the distance to a target provided that a line of sight exists. As seen in FIG. 5, two line of sight instruments 52, 53 are placed on the target 51, which defines a triangle with the angle β at the top and the angle θ at the right. Two lengths of the triangle are shown: L and d. The non-parallel β angle between the lines of sight instruments can be determined according to the teachings of this invention. If the distance d between the line of sight instruments is known, and if the angle θ between the line segment d and the right line of sight is known, the distance L to the target can be accurately determined from the law of sines:

$$L = d \frac{sin θ}{sin β} \qquad eqn . 2$$

Since the angle θ and the value of d are relatively easy to establish with a high accuracy, the accuracy of L is primarily dependent upon the accuracy of the measured angle β, which is the non-parallel angle between the two line of sights. This invention is particularly suited for measuring the angle β very accurately. Based on this invention, the accuracy of L is expected to be about ½ mil at 1,000 ft and under 5 mils at 10,000 ft (a mil is 1 part in 1000). This accuracy can be improved, with special care, by utilizing low machining tolerances and ensuring a low noise signal from a PSD.

The lines of sight to the target can be obtained from optical telescopes on a framework, or two rifle scopes may be connected together. Various adaptations can be made to control a small arms gun or a larger caliper weapon. The distance to target can be an input to a firing solution computer and used to control a gun automatically, or used to provide targeting corrections. Additional information from a triangular system can be obtained, such as elevation and rate of motion from the rotational speed of one or both line of sights, which is useful for measuring moving or flying targets.

This invention may also be used to align the barrels of parallel guns, such as an artillery battery.

When used in a target measuring system, the distance to target measurement is stealthy, and does not project a beam toward the target in order to determine the distance. The line of sight may be determined using optical devices that look at infrared light to allow targeting at night. Other wavelengths beside infrared can be utilized.

The distance between frames may be automatically sensed, or input by a user after measuring manually. Distance sensing devices are known and use light or reflected sound. In a preferred embodiment, the PSD can be adapted to measure the distance between the two frames. In an alternate preferred embodiment, the distance between the two frames is measured by a separate laser beam and receiving unit. An ultrasonic distance measurement may also be made. For a manual measurement, use of a steel tape provides sufficient accuracy.

PSD's are known in the art. Depending upon the model, a typical position accuracy is 2.1 micro meters (8.3×10⁻⁸ inches). In theory, this sensor is capable of providing a measuring angle error as low as 1.2×10⁻⁹ radians for rolls that are two feet apart. However, as a practical matter, this accuracy is generally not achievable in the field. The machining tolerances of the frames, the ability to set the first frame into position in a repeatable manner are bigger error sources. Also, the ability to consistently reflect the beam onto the PSD with a consistent output power is important. Based on laboratory experiments, angular accuracies below 0.00005 radians are readily obtainable when using a PSD, careful machining tolerances, and good operator practices.

While specific measuring methods, dimensional relationships, and computational methods have been disclosed herein, it should be recognized that the above novel disclosures will suggest adaptations to those skilled in the art to the measurement of other parallel and non parallel alignment orientations. Therefore, for the purpose of evaluating patent coverage for the disclosed invention, reference should be made to the appended claims for interpretation of the above disclosures.

I claim:

1. A method to measure an angular orientation between two surfaces comprising:
a. a first frame mounted on a first surface of said two surfaces,
b. a second frame mounted on a second surface of said two surfaces,
c. a mirror that is attached to said second frame in a manner to align said mirror to said second surface,
d. a collimated light source that is attached to said first frame which projects a collimated light beam,
e. a scale that is attached to said first frame which is adapted to measure the position of said collimated light beam,
f. wherein said scale is oriented substantially parallel to said first surface,
g. wherein said collimated light beam is directed onto said mirror and reflected onto said scale, wherein a first reading from said scale is made,
h. wherein said first frame is flipped over and re-mounted on said first surface,
i. wherein said collimated light beam is directed onto said mirror and reflected onto said scale, wherein a second reading from said scale is made,
j. a plane that is defined by the average path of said collimated light beam and an intersection with a line parallel to the measuring orientation of said scale, and
k. the distance between said first frame and said second frame is measured,
whereby said angular orientation between said first surface and said second surface is determined in said plane.

2. The method according to claim 1 wherein said scale is a position sensitive detector.

3. The method according to claim 1 wherein
a. said collimated light source is mounted on a first rotating axis wherein said first rotating axis is oriented parallel to said first surface, and
b. said mirror is mounted on a second rotating axis wherein said second rotating axis is oriented parallel to said second surface.

4. The method according to claim 1 whereby said first surface is a roll and said second surface is a roll.

5. The method according to claim 1 wherein said angular orientation between said two surfaces is used to determine the distance to a target.

6. The method according to claim 1 wherein the distance between said first frame and said second frame is measured by electronic sensors incorporating sound or light.

7. The method according to claim 1 wherein said second frame is flipped over between said first reading and said second reading.

8. The apparatus to measure an angular orientation between two surfaces comprising:
a. a first frame mounted on a first surface of said two surfaces,
b. a second frame mounted on a second surface of said two surfaces,
c. a mirror that is attached to said second frame in a manner to align said mirror to said second surface,
d. a collimated light source that is attached to said first frame which projects a collimated light beam,
e. a position indicating scale that is attached to said first frame which is adapted to measure the position of said collimated light beam,
f. wherein said scale is oriented substantially parallel to said first surface,
g. wherein said collimated light beam is directed onto said mirror and reflected onto said scale wherein a first reading is taken,
h. wherein said first frame is flipped over and re-mounted on said first surface,
i. wherein said collimated light beam is directed onto said mirror and reflected onto said scale wherein a second reading is taken,
j. a plane that is defined by the average path of said collimated light beam and an intersection with a line parallel to the measuring orientation of said scale, and
k. the distance between said first frame and said second frame is measured,
whereby said angular orientation between said first surface and said second surface in said plane is calculated.

9. The apparatus according to claim 8 wherein said scale is a position sensitive detector.

10. The apparatus according to claim 8 wherein
a. said collimated light source is mounted on a first rotating axis wherein said first rotating axis is oriented parallel to said first surface, and
b. said mirror is mounted on a second rotating axis wherein said second rotating axis is oriented parallel to said second surface.

11. The apparatus according to claim 8 wherein said first surface is a roll and said second surface is a roll.

12. The apparatus according to claim 8 wherein said angular orientation between said two surfaces is used to determine the distance to a target.

13. The apparatus according to claim 8 wherein the distance between said first frame and said second frame is measured by electronic sensors incorporating sound or light.

14. The method according to claim 8 wherein said second frame is flipped over between said first reading and said second reading.
